(19) United States
(12) Patent Application Publication
(10) Pub. No.: US 2006/0029289 A1
(43) Pub. Date: Feb. 9, 2006

(54) Information processing apparatus and method for detecting scene change

(75) Inventors: Tatsuo Yamaguchi, Tokyo (JP); Eiki Obara, Hiki-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/196,729

(22) Filed: Aug. 4, 2005

(30) Foreign Application Priority Data
Aug. 5, 2004 (JP) 2004-229520

(51) Int. Cl. G06K 9/40

(52) U.S. Cl. 382/274

(57) ABSTRACT

An information processing apparatus includes: an image processing unit that performs image processing for video data; and a detection unit that detects a scene change point where available to start or to cancel the image processing by the image processing unit based on a brightness signal in the video data having a value in a predetermined range.

### RELATED APPLICATIONS

The present disclosure relates to the subject matter contained in Japanese Patent Application No. 2004-229520 filed on Aug. 5, 2004, which is incorporated herein by reference in its entirety.

### BACKGROUND OF The INVENTION

1. Field of the Invention

This invention relates to an image processing technique in an information processing apparatus such as a personal computer.

2. Description of the Related Art

In recent years, a personal computer installing a TV tuner for enabling the user to view a TV broadcast program has begun to become widespread. Not a few machines perform image processing for video data by software with recent improvement of the CPU performance. One image processing is black extension processing.

In the black extension processing, for example, if video data contains 7.5 IRE setup or in a scene where the whole screen is bright, a signal less than one brightness signal (black extension start point) is expanded in the black direction, thereby improving contrast of black portion.

In order to perform image processing containing the black extension processing, consideration must be given so as not to give a sense of incompatibility to the viewer. This means that it is necessary to appropriately detect the start or cancel timing of the black extension processing, for example. In the description that follows, such a point may be called scene change point and detection of the point may be called scene change detection. Thus, various techniques for executing the scene change detection are proposed (For example, refer to JP-A-2004-032551).

### SUMMARY OF The INVENTION

As described in JP-A-2004-032551, if a normalization brightness histogram for each frame is calculated and a comparison is made between the two normalization brightness histograms continuous in time, highly accurate scene change detection can be conducted surely. Recently, however, the number of personal computers installing software of image processing algorithm containing black extension processing has increased as described above. Therefore, applying the technique in JP-A-2004-032551 to this kind of personal computer leads to a drastic increase in the load on a CPU; it is not practical. If scene change detection is performed using APL (Average Picture Level), still calculation of the APL leads to an increase in the CPU load.

The present invention provides an information processing apparatus and a scene change detection method of the apparatus for appropriately performing scene change detection while decreasing the CPU load.

According to a first aspect of the invention, there is provided an information processing apparatus including: an image processing unit that performs image processing for video data; and a detection unit that detects a scene change point where available to start or to cancel the image processing by the image processing unit based on a brightness signal in the video data having a value in a predetermined range.

According to a second aspect of the invention, there is provided a scene change detection method for an information processing apparatus having an image processing unit, the method including: performing image processing for video data; and detecting a scene change point where available to start or to cancel the image processing by the image processing unit based on a brightness signal in the video data having a value in a predetermined range.

### BRIEF DESCRIPTION OF The DRAWINGS

In the accompanying drawings:

FIG. 1 is a perspective view to show the appearance of a computer according to an embodiment of the invention;

FIG. 2 is a block diagram to show the system configuration of the computer of the embodiment of the invention;

FIG. 3 is a block diagram to show the functions of a TV application program installed in the computer of the embodiment of the invention;

FIG. 4 is a line graph to describe black extension processing performed in the computer of the embodiment of the invention;

FIG. 5 is a timing chart to describe the basic principle of scene change detection performed in the computer of the embodiment of the invention;

FIG. 6 is a first drawing to describe a determination condition in scene change detection performed in the computer of the embodiment of the invention;

FIG. 7 is a second drawing to describe a determination condition in scene change detection performed in the computer of the embodiment of the invention;

FIG. 8 is a third drawing to describe a determination condition in scene change detection performed in the computer of the embodiment of the invention; and

FIG. 9 is a flowchart to show a procedure of black extension processing containing scene change detection performed in the computer of the embodiment of the invention.

### DETAILED DESCRIPTION OF THE EMBODIMENT

Referring now to the accompanying drawings, a configuration of an information processing apparatus according to an embodiment of the invention will be discussed. The information processing apparatus is implemented as a notebook personal computer 10, for example.

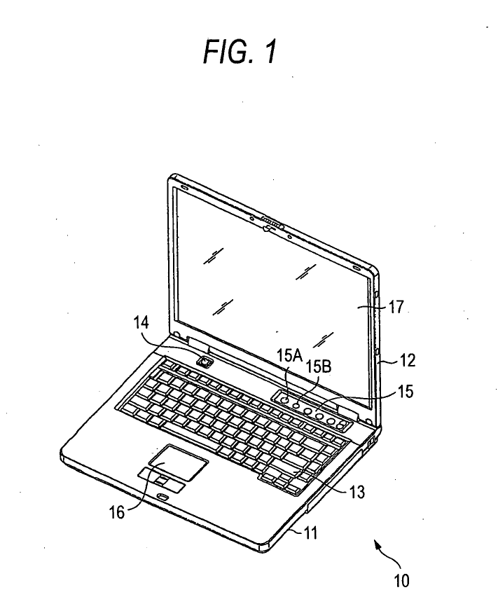

FIG. 1 is a front view of the notebook personal computer 10 with a display unit thereof open. The computer 10 is made up of a computer main unit 11 and a display unit 12. A display implemented as a TFT-LCD (Thin Film Transistor Liquid Crystal Display) 17 is built in the display unit 12, and a display screen of the LCD 17 is positioned almost in the center of the display unit 12.

The display unit 12 is attached to the computer main unit 11 for rotation between an open position and a closed position of the computer. The computer main unit 11 has a thin box-shaped cabinet on which a keyboard 13, a power button 14 for turning on/off power of the computer 10, an input operation panel 15, a touch pad 16, and the like are placed.

The input operation panel 15 is an input unit for inputting an event corresponding to the pressed button and includes a plurality of buttons for starting a plurality of functions. The buttons also contain a TV start button 15A and a DVD/CD start button 15B. The TV start button 15A is a button for starting a TV function for playing back and recording TV broadcast program data. When the user presses the TV start button 15A, a TV application program for executing the TV function is started automatically.

In the computer, a sub operating system dedicated to processing of AV (audio video) data as well as a general-purpose main operating system is installed. The TV application program is a program operating in the sub operating system.

When the user presses the power button 14, the main operating system is started. On the other hand, when the user presses the TV start button 15A, the sub operating system rather than the main operating system is started and the TV application program is performed automatically. The sub operating system has only the minimum function required for executing the AV function. Thus, the time required for booting up the sub operating system is far shorter than the time required for booting up the main operating system. Therefore, the user can instantly view/record a TV program simply by pressing the TV start button 15A.

The DVD/CD start button 15B is a button for playing back video content recorded on a DVD or a CD. When the user presses the DVD/CD start button 15B, a video playback application program for playing back video content is started automatically. The video playback application program is also an application program operating in the sub operating system. When the user presses the DVD/CD start button 15B, the sub operating system rather than the main operating system is started and the video playback application program is performed automatically.

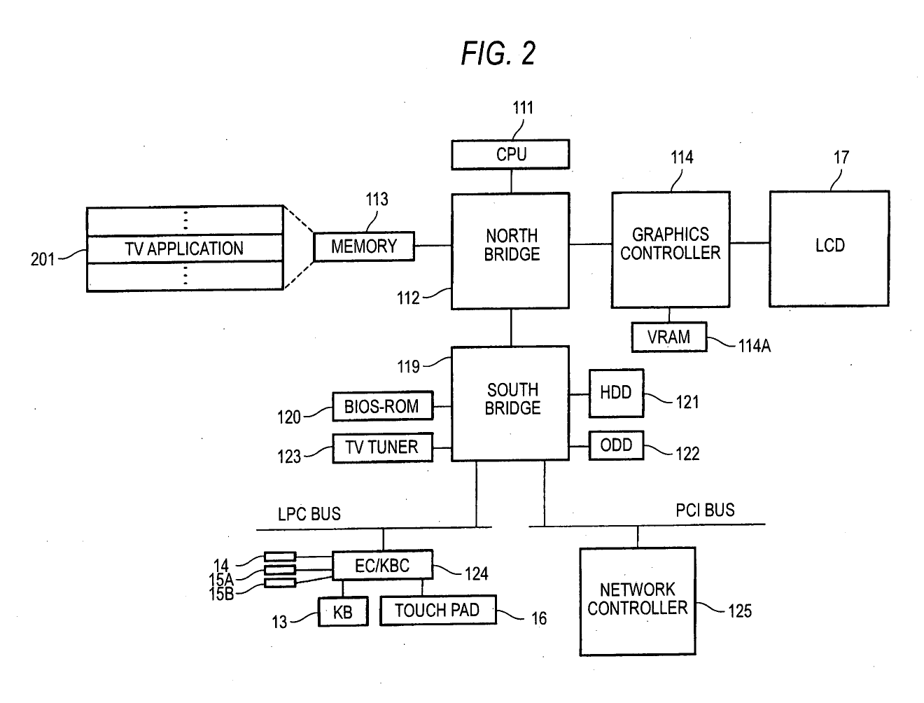

Next, the system configuration of the computer 10 will be discussed with reference to FIG. 2.

As shown in FIG. 2, the computer 10 includes a CPU 111, a north bridge 112, main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124, a network controller 125, and the like.

The CPU 111 is a processor provided for controlling the operation of the computer 10 and executes the main operating system (main OS), the sub operating system (sub OS), and various application programs such as a TV application program 201 loaded into the main memory 113 from the hard disk drive (HDD) 121.

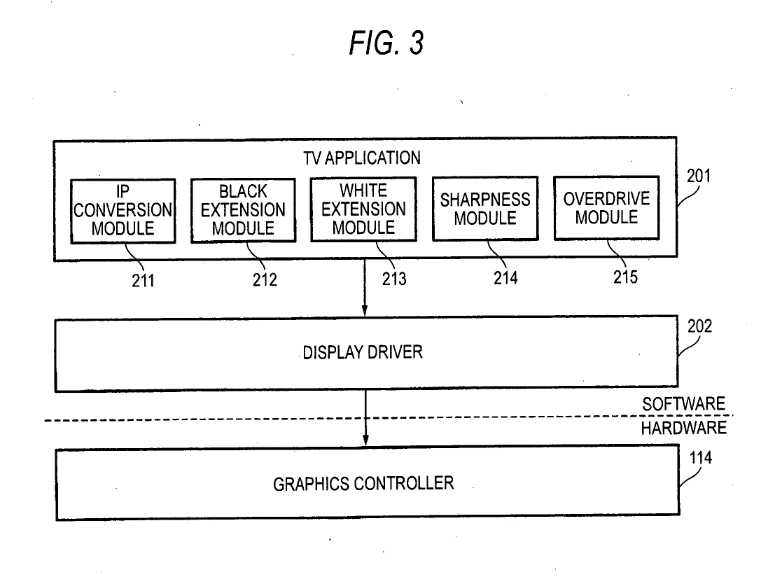

The TV application program 201 has a function of improving image quality of video data contained in TV broadcast program data received by the TV tuner 123. That is, the TV application program 201 includes an IP conversion module 211, a black extension module 212, a white extension module 213, a sharpness module 214, and an overdrive module 215 as the video processing functions to put the video data into high image quality, as shown in FIG. 3. The IP conversion module 211 executes progressive conversion processing for converting video data from interlace video into progressive video having the data amount twice that of the interlace video. In the progressive conversion processing, motion detection is performed in pixel units throughout all pixels of a video frame. The black extension module 212 and the white extension module 213 execute processing for performing expansion correction to black gradation and white gradation. The sharpness module 214 performs sharpness processing for edge enhancement and the like. The overdrive module 215 performs overdrive processing to improve the response speed of the LCD. The modules 211 to 215 make it possible to display video data of a TV broadcast program, etc., on the LCD 17 with high image quality. In the computer 10, a scene change point of the timing at which the black extension module 212 of the TV application program 201 can start or cancel black extension can be detected in smaller calculation amount than was previously possible.

The video data put into high image quality by the TV application program 201 is written into video memory (VRAM) 114A of the graphics controller 114 through a display driver 202. The display driver 202 is software for controlling the graphics controller 114.

The CPU 111 also executes system BIOS (Basic Input Output System) stored in the BIOS-ROM 120. The system BIOS is a program for controlling hardware.

The north bridge 112 is a bridge device for connecting a local bus of the CPU 111 and the south bridge 119. The north bridge 112 also contains a memory controller for controlling access to the main memory 113. The north bridge 112 also has a function of executing communications with the graphics controller 114 via an AGP (Accelerated Graphics Port) bus.

The graphics controller 114 is a display controller for controlling the LCD 17 used as a display monitor of the computer 10. The graphics controller 114 displays the video data written into the video memory (VRAM) 114A on the LCD 17.

The south bridge 119 controls devices on an LPC (Low Pin Count) bus and devices on a PCI (Peripheral Component Interconnect) bus. The south bridge 119 contains an IDE (Integrated Drive Electronics) controller for controlling the HDD 121 and the ODD 122. Further, the south bridge 119 has a function to control the TV tuner 123 and a function to control access to the BIOS-ROM 120.

The HDD 121 is storage for storing various types of software and various pieces of data. The optical disk drive (ODD) 122 is a drive unit for driving storage media such as a DVD and a CD storing video content. The TV tuner 123 is a receiver for receiving broadcast program data of a TV broadcast program, etc., from the outside.

The embedded controller/keyboard controller IC (EC/KBC) 124 is a one-chip microcomputer into which an embedded controller for power management and a keyboard controller for controlling the keyboard (KB) 13 and the touch pad 16 are integrated. The embedded controller/keyboard controller IC (EC/KBC) 124 has a function of turning on/off the power of the computer 10 in response to user's operation of the power button 14. Further, the embedded controller/keyboard controller IC (EC/KBC) 124 can also turn on the power of the computer 10 in response to user's operation of the TV start button 15A or the DVD/CD start button 15B. The network controller 125 is a communication unit for executing communications with an external network such as the Internet.

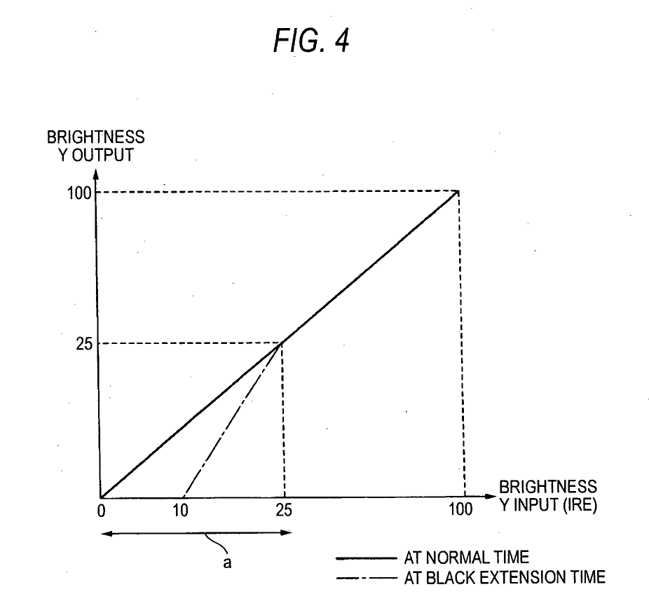

Next, the black extension processing performed by the black extension module 212 of the TV application program 201 will be discussed with reference to FIG. 4.

FIG. 4 is a line graph representing the levels of brightness signal of video data input to the black extension module 212 (0 to 100 IRE) on the horizontal axis and the levels of brightness signal of video data output from the black extension module 212 (0 to 100 IRE) on the vertical axis. As seen in FIG. 4, to perform the black extension processing for video data, the video data in the range of 10 to 25 IRE is expanded to the range of 0 to 25 IRE in the black direction (0 direction). The range of 10 to 25 IRE is for illustrative purpose only and the values of 10 IRE, 25 IRE, etc., have no meanings.

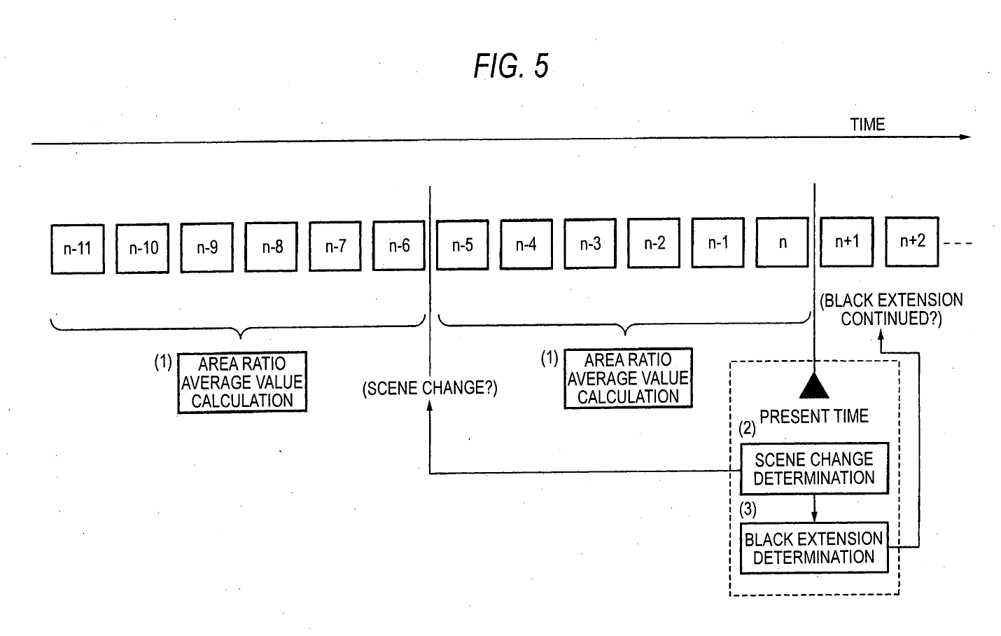

This means that the actually affected brightness signal portion in the black extension processing performed by the black extension module 212 is only in the range of 0 to 25 IRE (range a in FIG. 4) of all the range of 0 to 100 IRE. Then, focusing attention on this point, the computer 10 executes scene change detection from the measurement result of the video data only in the range of 0 to 25 IRE without calculating APL or histograms. FIG. 5 is a timing chart to describe the basic principle of scene change detection performed by the computer 10.

FIG. 5 assumes that the time passage is represented from the left to the right and that the frames of video data contained in TV broadcast program data received by the TV tuner 123 advance from n−11 to n−10, . . . , to n−1 to n to n+1, . . . In such a circumstance, the black extension module 212 calculates the average value of the area ratio of the brightness signal in the range of 0 to 25 IRE to the whole screen every six frames ((1) in FIG. 5). This means that the black extension module 212 measures only the range of the actually affected brightness signal in the black extension processing. The six frames of the calculation unit of the area ratio average value are for illustrative purpose only.

After calculating the area ratio average value, the black extension module 212 uses the most recent area ratio average value and the immediately preceding area ratio average value to determine whether or not the point between the former frame group (frames n−5 to n) and the latter frame group (frames n−11 to n−6) may be adopted as the scene change point where the black extension processing can be started or canceled ((2) in FIG. 5). This determination is made by whether or not the following conditions are satisfied:

(1) Change Amount

(a) Area Ratio Increases or Decreases X (for Example, 3)% or More

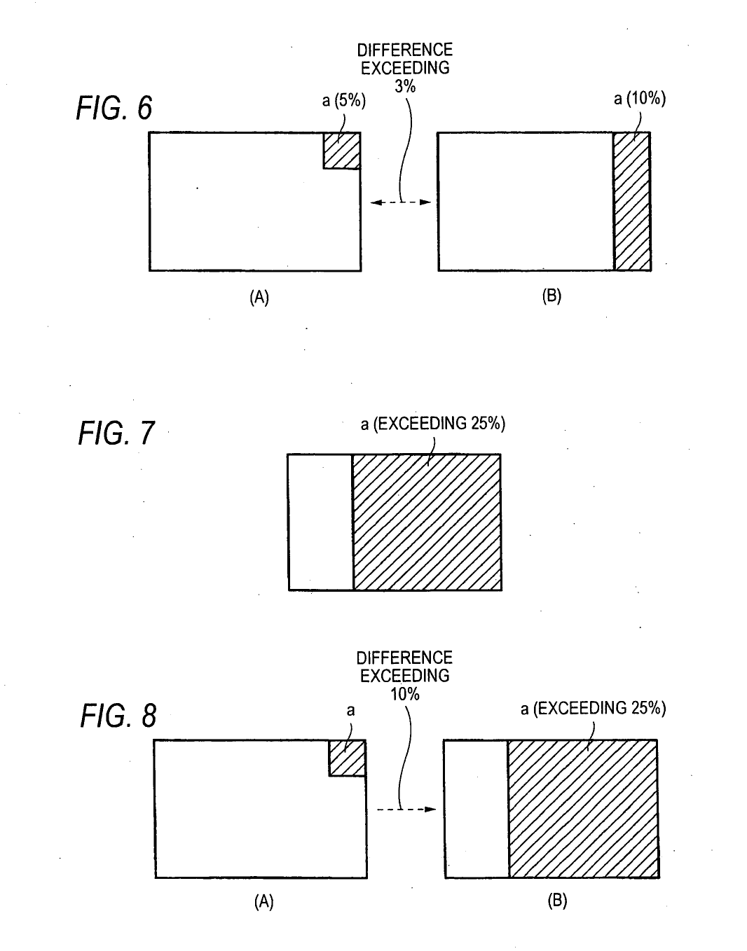

If this condition is not satisfied, the black extension module 212 determines that the point is not the scene change point. In the example shown in FIG. 6, the area ratio of the brightness signal in the range of 0 to 25 IRE (range a in FIG. 4) to the whole screen is 5% in (A) and 10% in (B), and the difference therebetween exceeds 3% and therefore the change amount condition can be cleared between (A) and (B). If the condition is satisfied, subsequently the black extension module 212 checks whether or not the following area ratio condition holds:

(2) Area Ratio

(a) Area Ratio is Y (for Example, 25)% or less

If this condition is not satisfied, namely, if the area to which the black extension processing is applied exceeds Y %, basically the black extension module 212 suppresses detecting that the point is the scene change point (if the area ratio increases or decreases X % or more) for safety so as not to give a sense of incompatibility caused by brightness change of the expansion portion to the viewer. In contrast, if the condition is satisfied, at the point in time, the black extension module 212 determines that the point is the scene change point. In the example shown in FIG. 7, the area ratio of the brightness signal in the range of 0 to 25 IRE (range a in FIG. 4) to the whole screen exceeds 25% and therefore basically the area ratio condition is not cleared.

If the area to which the black extension processing is applied exceeds Y %, the black extension module 212 further checks whether or not the following condition as a secondary condition holds:

(b) Area Ratio Increases Z (for Example, 10)% or More

If this condition is satisfied, the black extension module 212 determines that the screen composition changes to such an extent that brightness change of the expansion portion does not give a sense of incompatibility to the viewer if the area to which the black extension processing is applied exceeds Y %, cancel suppression for safety, and determines that the point is the scene change point. That is, although the area ratio exceeds 25% as in the example shown in FIG. 7, if an increase exceeding 10% like (A)->(B) is involved as in the example shown in FIG. 8, exceptionally the area ratio condition is cleared.

Thus, the computer 10 measures only (1) change amount and (2) area ratio in the range of the brightness signal actually affected in the black extension processing for detecting the scene change point where the black extension processing can be started or canceled, so that the required calculation amount can be reduced as compared with that according to the conventional technique.

Upon detection of the scene change point, the black extension module 212 determines whether or not the black extension processing should be performed based on the most recent area ratio average value ((3) in FIG. 5). To determine whether or not the black extension processing should be performed, any determination procedure may be adopted in the computer 10 in such a manner that the black extension processing is performed if the number of brightness signals in the range of 0 to 10 IRE in the range a shown in FIG. 4 is a predetermined number or less, for example.

As a result, a six-frame shift occurs between the scene change point and the start or cancel timing of the black extension processing, but such a delay can be ignored in view with the naked eyes.

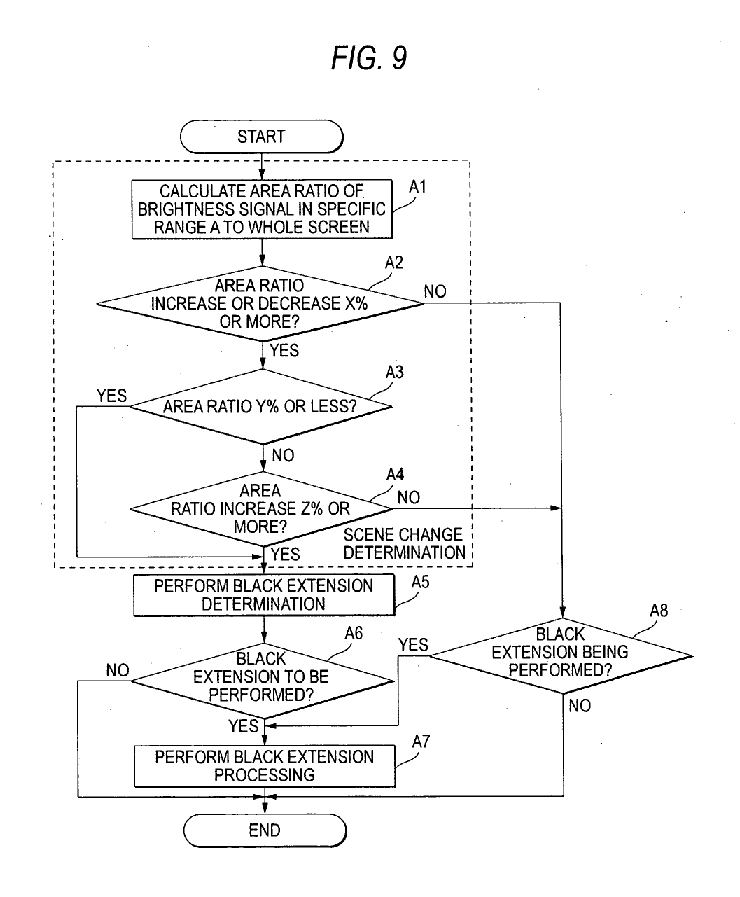

Next, the procedure of the black extension processing containing scene change detection performed by the computer 10 will be discussed with reference to a flowchart of FIG. 9.

First, the black extension module 212 calculates the area ratio of the brightness signal in a specific range actually affected in the black extension processing to the whole screen about video data of TV broadcast program data received from the TV tuner 123 (step A1) After calculating the area ratio, the black extension module 212 determines whether or not the area ratio increase or decrease is X (for example, 3)% or more (step A2).

If the area ratio increase or decrease is X % or more (YES at step A2), subsequently the black extension module 212 determines whether or not the area ratio is Y (for example, 25)% or less (step A3) At this time, if the area ratio exceeds Y % (NO at step A3), the black extension module 212 further determines whether or not the area ratio increases Z (for example, 25)% or more (step A4).

As the result of the determinations, if (1) the area ratio increase or decrease is X % or more and (2) the area ratio is Y % or less or the area ratio increases Z % or more (namely, YES at step A2 and YES at step A3 or YES at step A2, NO at step A3, and YES at step A4), the black extension module 212 determines that the point is a scene change point, and determines whether or not black extension is to be performed (step A5). If the black extension module 212 determines that black extension is to be performed based on a predetermined criterion (YES at step A6), it executes the black extension processing (step A7).

On the other hand, if (1) the area ratio increase or decrease is less than X % or if (2) the area ratio exceeds Y % and the area ratio increases less than Z % although (1) the area ratio increase or decrease is X % or more (namely, NO at step A2 or YES at step A2, NO at step A3, and NO at step A4), the black extension module 212 determines that the point is not a scene change point. If black extension is being performed (YES at step A8), the black extension processing is continued (step A7).

The determination as to whether or not black extension is being performed at step A8 is written expressly; in fact, no operation is performed at the step (consequently, if black extension is being performed, the black extension is continued; otherwise, the cancel state of black extension is kept). On the other hand, at steps A6 and A7, black extension start, cancel, or continuation of either state is not considered at all. If it is determined that black extension is to be performed during execution of black extension, consequently the black extension is continued; if it is determined that black extension is not to be performed, consequently the black extension is canceled. In contrast, if it is determined that black extension is to be performed when black extension is not performed, consequently the black extension is started; if it is determined that black extension is not to be performed, consequently cancel of black extension is continued.

As described above, the computer 10 executes scene change detection from the measurement result of only the range of the brightness signal actually affected in the black extension processing, whereby appropriate scene change detection is made possible while the CPU load is decreased.

In the description of the embodiment, the scene change detection technique is applied for detecting the timing at which the black extension processing can be started or canceled by way of example, but the invention is not limited to it. The scene change detection technique can be applied to detection of the attribute change timing, etc., in various types of image processing.

That is, it is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

As described with reference to the embodiment, there is provided the information processing apparatus and the scene change detection method of the apparatus for making possible appropriate scene change detection while decreasing the CPU load.

The foregoing description of the embodiment of the invention has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. An information processing apparatus comprising:
an image processing unit that performs image processing for video data; and
a detection unit that detects a scene change point where available to start or to cancel the image processing by the image processing unit based on a brightness signal in the video data having a value in a predetermined range.

2. The information processing apparatus according to claim 1, wherein the image processing unit is a black extension processing unit that performs black extension processing for the video data.

3. The information processing apparatus according to claim 2, wherein the detection unit detects the scene change point using only the brightness signal of the video data expanded by the black extension processing unit as the brightness signal having a value in the predetermined range.

4. The information processing apparatus according to claim 3, wherein the predetermined range is 0 to 25 IRE.

5. The information processing apparatus according to claim 1 wherein the detection unit includes calculation unit that calculates an area ratio of the brightness signal having a value in the predetermined range to the whole screen, and
wherein the detection unit detects that a point where the area ratio increases or decreases exceeding a predetermined percentage as the scene change point.

6. The information processing apparatus according to claim 5, wherein the predetermined percentage is 3%.

7. The information processing apparatus according to claim 5, wherein when the area ratio calculated by the calculation unit exceeds a predetermined value, the detection unit suppresses detection of the scene change point.

8. The information processing apparatus according to claim 7, wherein the predetermined value is 25%.

9. The information processing apparatus according to claim 7, wherein when the area ratio calculated by the calculation unit increases exceeding a second predetermined percentage, the detection unit cancels suppressing the detection of the scene change point.

10. The information processing apparatus according to claim 9, wherein the second predetermined percentage is 10%.

11. The information processing apparatus according to claim 1 further comprising a receiver that receives television broadcast program data,
wherein the video data is contained in the television broadcast program data received by the receiver.

12. A scene change detection method for an information processing apparatus having an image processing unit, the method comprising:
performing image processing for video data; and
detecting a scene change point where available to start or to cancel the image processing by the image processing unit based on a brightness signal in the video data having a value in a predetermined range.

13. The method according to claim 12 further comprising calculating an area ratio of the brightness signal having a value in the predetermined range to the whole screen,
wherein the scene change point is detected at a point where the area ratio increases or decreases exceeding a predetermined percentage.

14. The method according to claim 13, wherein when the calculated area ratio exceeds a predetermined value, the detection of the scene change point is suppressed.

15. The method according to claim 14, wherein when the calculated area ratio increases exceeding a second predetermined percentage, the suppressing the detection of the scene change point is canceled.
